(19) United States
(12) Patent Application Publication
(10) Pub. No.: US 2018/0269017 A1
(43) Pub. Date: Sep. 20, 2018

(54) CONTACT DEVICE AND ELECTROMAGNETIC CONTACTOR USING SAME

(71) Applicant: FUJI ELECTRIC FA COMPONENTS & SYSTEMS CO., LTD., Tokyo (JP)

(72) Inventors: Koujun KONISHI, Kounosu-city (JP); Yuki TASHIMA, Kitamoto-city (JP); Hideo ADACHI, Fukaya-city (JP); Yasuhiro NAKA, Kitamoto-city (JP); Kouetsu TAKAYA, Kounosu-city (JP); Yuya SAKURAI, Kounosu-city (JP)

(21) Appl. No.: 15/986,311

(22) Filed: May 22, 2018

Related U.S. Application Data
(63) Continuation of application No. PCT/JP2017/010349, filed on Mar. 15, 2017.

(30) Foreign Application Priority Data
Jun. 14, 2016 (JP) 2016-117918
Jan. 11, 2017 (JP) 2017-002287

(51) Int. Cl. H01H 50/54; H01H 51/29; H01H 50/14; H01H 50/56; H01H 47/00; H01H 50/36; H01H 50/02; H01H 50/20

(52) U.S. Cl. CPC H01H 50/541; H01H 51/29; H01H 50/14; H01H 50/546; H01H 50/56; H01H 2050/025; H01H 50/36; H01H 50/023; H01H 50/20; H01H 2050/028; H01H 47/002

(57) ABSTRACT

A contact device includes a main contact mechanism including a pair of main stationary contact members and a main movable contact member; an auxiliary contact mechanism disposed at a position different from that of the main contact mechanism and including auxiliary stationary contact members and auxiliary movable contact members; a movable shaft configured to operate the main movable contact member and the auxiliary movable contact member in conjunction with each other; rod-shaped auxiliary terminals electrically connected to the auxiliary stationary contact members; a cover plate having holes through which the auxiliary terminals penetrate; an insulating case configured to house the main contact mechanism and the auxiliary contact mechanism and including an auxiliary terminal case section configured to separate the main contact mechanism and the auxiliary contact mechanism from each other; and a cylindrical body covering the insulating case exteriorly and joined to the cover plate.

### TECHNICAL FIELD

This invention relates to a contact device configured to open/close a current path and an electromagnetic contactor including the contact device.

### BACKGROUND ART

Examples of electromagnetic switches include one having a main contact mechanism configured to apply/interrupt high current and an auxiliary contact mechanism configured to operate in conjunction with the main contact mechanism, as illustrated in PTL 1. With such an electromagnetic switch, a conduction state of the main contact mechanism may be understood by connecting a detection circuit to the auxiliary contact mechanism.

### CITATION LIST

### Patent Literature

PTL 1: US2008/0084260

### SUMMARY OF INVENTION

### Technical Problem

In the electromagnetic contactor described in PTL 1, however, the main contact mechanism is not directly connected with the auxiliary contact mechanism; thus, it is difficult to detect welding of a stationary contact member and a movable contact member of the main contact mechanism.

### Solution to Problem

To solve the aforementioned problem, a contact device according to an aspect of the present invention includes a main contact mechanism including a pair of main stationary contact members spaced apart from each other at a certain distance and a main movable contact member supported such that it can come into and out of contact with the main stationary contact members; an auxiliary contact mechanism including auxiliary stationary contact members disposed at a position different from that of the main contact mechanism and spaced apart from each other at a certain distance and an auxiliary movable contact member supported such that it can come into and out of contact with the auxiliary stationary contact members; a movable shaft configured to operate the main movable contact member and the auxiliary movable contact member in conjunction with each other; a rod-shaped auxiliary terminal electrically connected to the auxiliary stationary contact member; and a contact housing unit comprising a cover plate having a hole through which the auxiliary terminal penetrates, an insulating case configured to house the main contact mechanism and the auxiliary contact mechanism and including an auxiliary terminal case section configured to separate the main contact mechanism and the auxiliary contact mechanism from each other, and a cylindrical body covering the insulating case exteriorly and joined to the cover plate, wherein fitting portions fitted with each other are formed in junction sections of the cover plate and the auxiliary terminal case section.

### Advantageous Effects of Invention

According to an aspect of the present invention, welding of the stationary contact member and the movable contact member of the main contact mechanism may be reliably detected. In addition, a creepage distance between the main contact unit and a gap formed between the cover plate and the insulating case may be made longer, thereby preventing an arc generated in the main contact unit from coming into contact with the auxiliary terminal.

### BRIEF DESCRIPTION OF DRAWINGS

FIG. 1 is a sectional view along a longitudinal direction of a main movable contact member, illustrating a first embodiment of an electromagnetic contactor including a contact device according to the present invention;

FIG. 2 is a sectional view along a width direction of the main movable contact member, illustrating the electromagnetic contactor according to the first embodiment;

FIG. 3 is an exploded perspective view of the contact device according to the present invention;

FIG. 4 is a perspective view illustrating auxiliary terminals of the contact device according to the present invention;

FIG. 5 is a sectional view illustrating the auxiliary terminals of the contact device according to the present invention;

FIG. 6 is an enlarged view of a section X in FIG. 5;

FIG. 7 is an exploded perspective view similar to FIG. 3, illustrating a second embodiment of the contact device according to the present invention;

FIG. 8 is a sectional view similar to FIG. 6, illustrating the second embodiment of the contact device according to the present invention;

FIG. 9 is a sectional view similar to FIG. 6, illustrating a third embodiment of the contact device according to the present invention;

FIG. 10 is a sectional view similar to FIG. 6, illustrating a modification of the third embodiment of the contact device according to the present invention;

FIG. 11 is an exploded perspective view, illustrating a fourth embodiment of the present invention with some portions removed;

FIG. 12 is an exploded perspective view of the contact device illustrated in FIG. 11;

FIG. 13 is a sectional view of the fourth embodiment along a longitudinal direction of the main movable contact member;

FIG. 14 is a sectional view of the fourth embodiment along a width direction of the main movable contact member;

FIG. 15 is a perspective view of a movable shaft;

FIG. 16 is an exploded perspective view of the movable shaft; and

FIG. 17 is a sectional view similar to FIG. 13, illustrating a modification of the movable shaft.

### DESCRIPTION OF EMBODIMENTS

Next, referring to the drawings, an embodiment of the present invention will be described. In the description of the drawings, same or similar elements are denoted by the same or similar reference signs. It should be noted that the drawings are schematic and relations between thicknesses and two-dimensional dimensions, ratios between thicknesses of respective layers, and the like may be different from actual ones. Thus, specific thicknesses and dimensions should be determined in consideration of the following descriptions. It goes without saying that relations between corresponding dimensions and ratios between respective dimensions may be different between drawings.

The embodiments to be described below are intended to exemplify a device and a method for embodying the technical idea of the present invention, and the technical idea of the present invention does not limit materials, shapes, structures, arrangements, and the like of components to those described below. Various modifications may be made to the technical idea of the present invention within the technical scope defined by the claims.

Next, referring to the figures, embodiments of the present invention will be described.

### First Embodiment

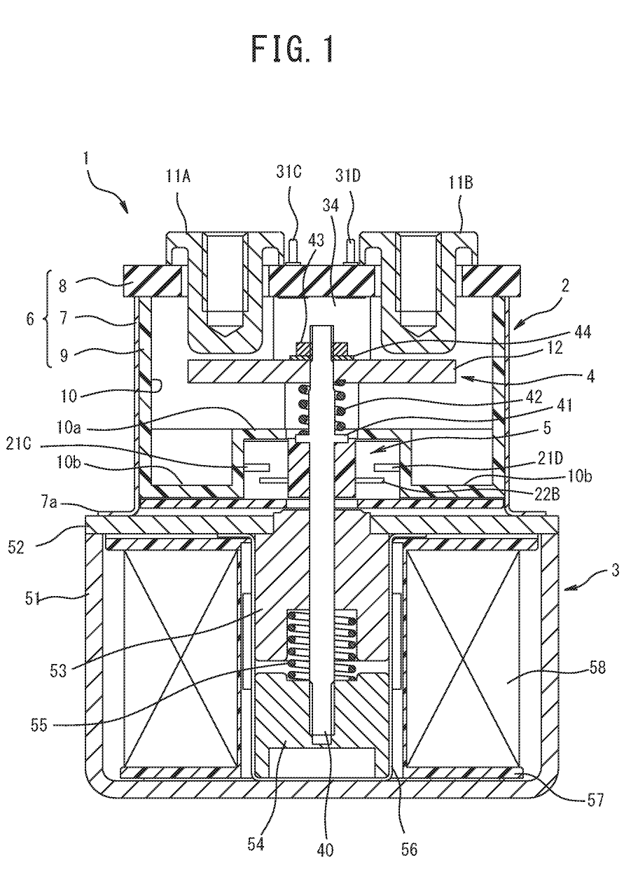

A first embodiment according to the present invention will be described with reference to FIG. 1 to FIG. 6.

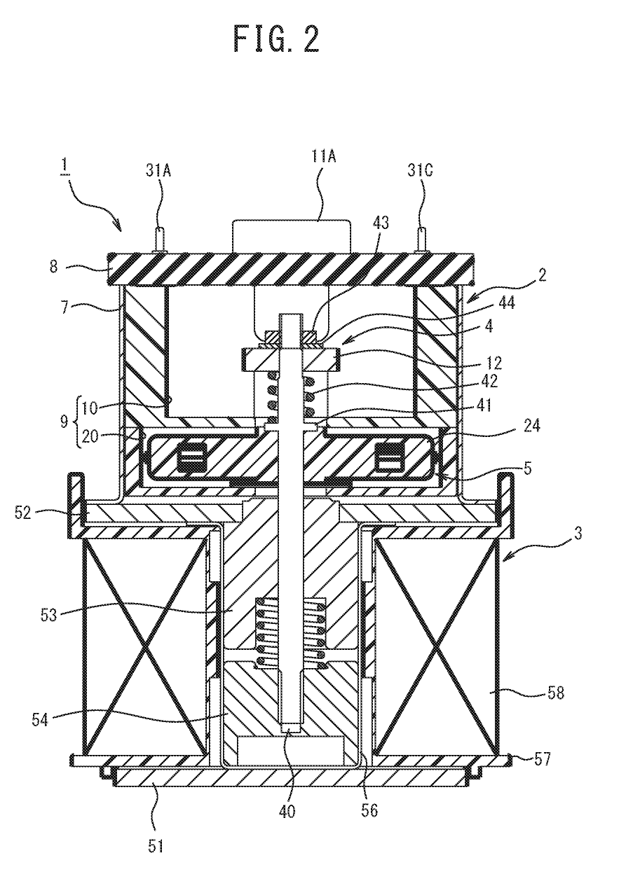

An electromagnetic contactor 1 includes, as illustrated in FIG. 1 and FIG. 2, a contact device 2 having a contact mechanism and an electromagnet unit 3 configured to drive the contact mechanism.

The contact device 2 includes a contact housing unit 6 configured to house a main contact mechanism 4 and an auxiliary contact mechanism 5. The contact housing unit 6 includes a metallic outer square-cylindrical body 7, a cover plate 8 made of an insulating material, for example, a ceramic or the like, configured to close an upper end of the outer square-cylindrical body 7, and an insulating case 9 housed in the outer square-cylindrical body 7.

The outer square-cylindrical body 7 has a flange 7a formed at an end portion on a side opposite to the cover plate 8, and is fixed to an upper magnetic yoke 52 to be described later by joint sealing.

The cover plate 8 is formed as a flat plate, and there are arranged, in the center, through-holes configured to individually support each of a pair of main stationary contact members 11A, 11B to be described later at a certain distance from each other in a longitudinal direction.

Two pairs of auxiliary terminals 31A, 31B and 31C, 31D to be described later are also arranged in the cover plate 8, each of the pair being arranged at a certain distance from each other in the longitudinal direction such that the auxiliary terminals are in parallel to the pair of main stationary contact members 11A, 11B, and the auxiliary terminals 31A, 31B, 31C, and 31D are respectively inserted through through-holes 32A, 32B, 32C, and 32D for the auxiliary terminals formed in the cover plate 8 and fixed. The two pairs of auxiliary terminals 31A, 31B and 31C, 31D are arranged at a certain distance from each other in a transverse direction of the cover plate 8. On the back surface of the cover plate 8, recessed portions 33 are formed at the periphery of the respective through-holes 32 for the auxiliary terminals.

The insulating case 9 is formed by arranging a main contact case 10 configured to house the main contact mechanism 4 and an auxiliary contact case 20 configured to house the auxiliary contact mechanism 5 arranged in series in an axial direction.

The main contact mechanism 4 includes the pair of main stationary contact members 11A, 11B and a main movable contact member 12 supported such that it can come into and out of contact with the pair of main stationary contact members 11A, 11B.

The main stationary contact members 11A, 11B are inserted through the through-holes in the cover plate and fixed in an airtight manner by brazing, welding or the like. The main stationary contact members 11A, 11B respectively have a contact portion at an end portion projecting inside the main contact case 10.

The main movable contact member 12 is formed of a plate-shaped conductive material extending in a longitudinal direction of the contact housing unit 6, and disposed at a predetermined position such that it can move in the axial direction, supported by a movable shaft 40 to be described later. Between a lower side of the main movable contact member 12 and a spring receiving portion 41 formed on the movable shaft 40, a contact spring 42 is interposed, and the main movable contact member 12 is pressed upwards by the contact spring 42. An upper face of the main movable contact member 12 is abutted via a washer 44 to a locking screw 43 screwed to the movable shaft 40, and is prevented from dropping upwards.

The main contact case 10 for housing the main contact mechanism 4 is a tub-shaped body with an open upper end. On a bottom plate portion 10a, as illustrated in FIG. 1, arc-extinguishing recessed portions 10b are formed by denting portions facing against peripheries of the contact portions of the main stationary contact members 11A, 11B and the main movable contact member 12 toward the auxiliary contact case 20 side. In the center of the bottom plate portion 10a, a through-hole is formed and the movable shaft 40 is inserted through the through-hole.

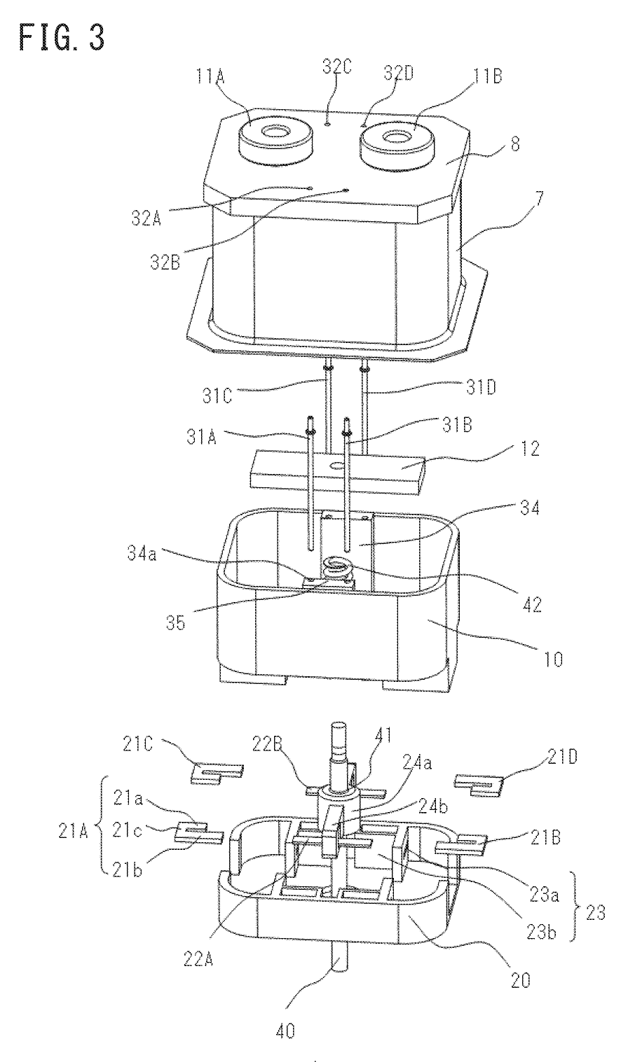

On an inner wall surface of the main contact case 10 in parallel to the movable contact member 12, a pair of auxiliary terminal case sections 34 are formed facing against each other. At one end of the auxiliary terminal case section 34, as illustrated in FIG. 3 to FIG. 5, a protruding portion 35, projecting from an upper end of the surrounding wall surface of the main contact case 10, is formed, and the protruding portion 35 is fitted with the recessed portion 33 formed on the back surface of the cover plate 8 during assembly. The protruding portion 35 and the recessed portion 33 form fitting portions at which they are fitted with each other. Fitting, as used here, is not limited to a case in which the protruding portion 35 and the recessed portion 33 are fitted without any gap, but also includes a case in which the protruding portion 35 and the recessed portion 33 are fitted with a gap in between.

The auxiliary contact mechanism 5 includes, for example, four auxiliary stationary contact members 21A to 21D housed in the auxiliary contact case 20 and disposed at positions sandwiching the arc-extinguishing recessed portion 10b of the main contact case 10 and two auxiliary movable contact members 22A, 22B supported such that they can come into and out of contact with the auxiliary stationary contact members 21A to 21D.

The auxiliary stationary contact members 21A to 21D are made of, for example, a spring material, and as illustrated in FIG. 3, formed with a contact plate portion 21a, an elastic plate portion 21b, and a connecting plate portion 21c connecting these plate portions in a substantially U shape when viewed from a plane. In the auxiliary contact case 20, auxiliary stationary contact member holding sections 23 are provided, and the contact plate portion 21a of the auxiliary stationary contact members 21A to 21D is inserted into an auxiliary stationary contact member holding hole 23a formed in the auxiliary stationary contact member holding section 23 and held. In this case, the contact plate portion 21a extends along a wall portion 23b of the auxiliary stationary contact member holding section 23 and disposed at a position facing against the auxiliary movable contact members 22A, 22B while the elastic plate portion 21b extends in parallel to the contact plate portion 21a across the wall portion 23b from. The connecting plate portion 21c connects one end of the contact plate portion 21a with one end of the elastic plate portion 21b across the wall portion 23b.

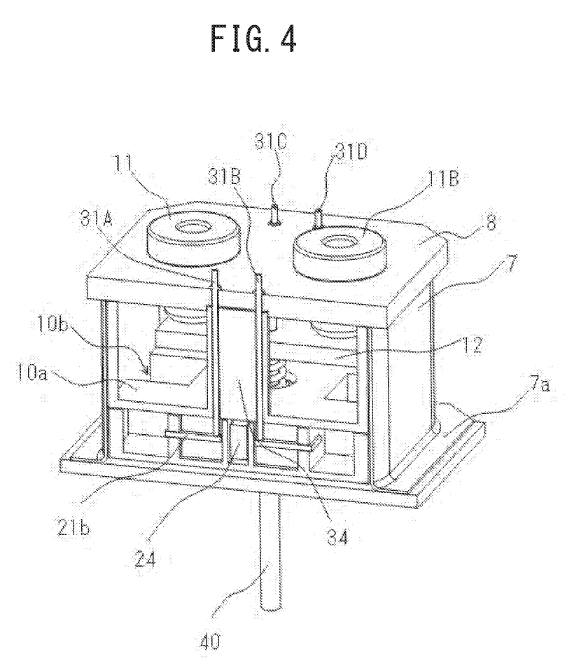

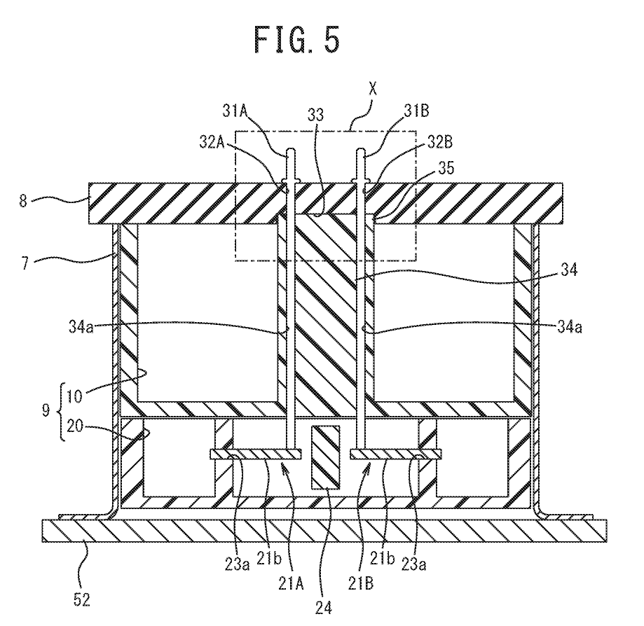

The elastic plate portions 21b of the auxiliary stationary contact members 21A to 21D are respectively connected to the auxiliary terminals 31A to 31D as illustrated in FIG. 4 and FIG. 5. The auxiliary terminals 31A to 31D are formed of conductive metal in a rod shape, and respectively inserted into the through-holes 32A to 32D for the auxiliary terminals in the cover plate 8 through pass-through sections 34a of the auxiliary terminal case sections 34, and are in contact with the elastic plate portions 21b of the auxiliary stationary contact members at the tips.

An auxiliary movable contact member holding section 24 configured to hold the auxiliary movable contact members 22A, 22B is formed of an insulating material, and includes a cylindrical portion 24a and a pair of contact housing sections 24b formed outside the cylindrical portion 24a and projecting in a radial direction. In the contact housing section 24b, the auxiliary movable contact members 22A, 22B are disposed such that they are in parallel to the main movable contact member 12, and individually pressed by a contact pressing spring (not illustrated) in either upward or downward direction. In the present embodiment, the auxiliary stationary contact members 21A and 21B and the auxiliary movable contact member 22A constitute a normally open contact while the auxiliary stationary contact members 21C and 21D and the auxiliary movable contact member 22B constitute a normally closed contact.

The auxiliary movable contact member holding section 24 is disposed between the arc-extinguishing recessed portions 10b formed in the main contact case 10. The movable shaft 40 penetrates through the center of the cylindrical portion 24a and is fixed, and the movable shaft 40 is inserted through a through-hole formed in the bottom plate portion of the auxiliary contact case 20. This structure allows the auxiliary movable contact member holding section 24 to move in the axial direction in conjunction with the main movable contact member 12.

The electromagnet unit 3 includes a lower magnetic yoke 51 and a plate-shaped upper magnetic yoke 52 joining an open end of the lower magnetic yoke 51. A cylindrical stationary core 53 is fixedly disposed on a bottom side of the upper magnetic yoke 52, and a cylindrical movable core 54 is disposed on a side opposite to the upper magnetic yoke 52 across the stationary core 53 such that it can move in the axial direction. A return spring 55 is interposed between the stationary core 53 and the movable core 54, and biases the movable core 54 in a direction away from the stationary core 53. The movable shaft 40 supporting the main movable contact member 12 and the auxiliary movable contact member holding section 24 is inserted through a through-hole formed in the center of the stationary core 53, and fixed to the movable core 54 at one end.

The stationary core 53 and the movable core 54 are covered by a bottomed cylindrical cap 56, and one end of the cap 56 is joined to a lower face of the upper magnetic yoke 52 in an airtight manner. Furthermore, as described above, the flange 7a of the outer square-cylindrical body is joined to an upper face of the upper magnetic yoke 52 in an airtight manner, thereby constituting a contact device 2 hermetically sealed by the contact housing unit 6 and the cap 56. In the hermetically sealed contact device 2, an arc-extinguishing gas, for example, hydrogen or the like is enclosed. A spool 57 is disposed on an outer peripheral side of the cap 56, and an excitation coil 58 is wound on the spool 57.

Next, an operation of the aforementioned first embodiment will be described.

It is assumed that, for example, the main stationary contact member 11A is connected to a power supply source supplying high current and the main stationary contact member 11B is connected to a load.

In this case, the excitation coil 58 in the electromagnet unit 3 is in a non-excited state, and the movable shaft 40 connected with the electromagnet unit 3 does not move upwards.

In the non-excited state, the main movable contact member 12 supported by the movable shaft 40 is separated from the main stationary contact members 11A, 11B and both contacts are in an open state in which they are electrically disconnected.

In the auxiliary contact mechanism 5, the auxiliary movable contact members 22A is separated from the auxiliary stationary contact members 21A, 21B and is in an open state. In contrast, the auxiliary movable contact member 22B is in contact with the auxiliary stationary contact members 21C, 21D and energized to be in a closed state.

When the excitation coil 58 is energized, an excitation force is generated by the electromagnet unit 3 to move the movable core 54 upwards toward the stationary core 53 against a biasing force of the return spring 55. Thus, the movable shaft 40 connected with the movable core 54 is moved upwards.

In response to this, the main movable contact member 12 connected with the movable shaft 40 moves upwards and comes into contact with the main stationary contact members 11A, 11B with a contact pressure of the contact spring 42, and enters an energized state.

In the auxiliary contact mechanism 5, the auxiliary movable contact member 22A comes into contact with the auxiliary stationary contact members 21A, 21B and enters a closed state. In contrast, the auxiliary movable contact member 22B is separated from the auxiliary stationary contact members 21C, 21D and enters an open state.

To interrupt energization of the main contact mechanism 4, energization of the excitation coil 58 is stopped. With this operation, the electromagnet unit 3 enters a non-excited state, and the movable core 54 is pressed by the biasing force of the return spring 55 to be separated from the stationary core 53. Since the movable shaft 40 moves downwards at the same time, the main contact mechanism 4 enters an open state while one of the two pairs of the auxiliary contact mechanisms 5 enters an open state and the other enters a closed state.

When the main contact mechanism 4 enters an open state, an arc is generated between the main stationary contact members 11 and the main movable contact member 12. The generated arc is extended by an arc-extinguishing permanent magnet (not illustrated) disposed outside the main contact case 10. At this time, since the arc-extinguishing recessed portions 10b are formed in the bottom plate portion 10a of the main contact case 10 at positions facing against both ends of the main movable contact member 12, an arc length may be further extended and an interruption performance may be improved.

Furthermore, an auxiliary terminal case sections 34 are formed on the inner wall surface along the main movable contact member 12 in a direction different from the arc extension direction; thus, an arc may not readily act on the auxiliary terminals 31A to 31D inserted through the auxiliary terminal case sections 34 by this structure.

In addition, since the protruding portion 35 is formed on an upper end of the auxiliary terminal case section 34, positions at which the auxiliary terminals 31A to 31D are exposed are higher than that of an upper face of the wall surface of the main contact case 10; thus, a creepage distance between the auxiliary terminals 31A to 31D and the portion at which arc is generated through a gap between the cover plate 8 and the auxiliary terminal case section 34 becomes even longer, thereby preventing an arc from entering the gap to come into contact with the auxiliary terminals 31A to 31D.

Furthermore, since it is configured that the arc-extinguishing recessed portions 10b are formed between the movable contact members 22A and 22B in the auxiliary movable contact member holding section 24, it is not necessary to form a separate arc-extinguishing space for the arc-extinguishing recessed portion 10b; thus, the height of the contact device 2 may be made lower.

It is to be noted, although, in the auxiliary contact mechanism 5 in the present embodiment, the auxiliary stationary contact members 21A and 21B and the auxiliary movable contact member 22A constitute a normally open contact while the auxiliary stationary contact members 21C and 21D and the auxiliary movable contact member 22B constitute a normally closed contact, the configuration is not limited to this and the auxiliary contact mechanism 5 may be configured with two pairs of normally open contacts or normally closed contacts.

Furthermore, the protruding portion 35 in the present embodiment are not limited to the same cross-sectional shape as the auxiliary terminal case section 34, and may be a cross-sectional shape smaller or larger than the auxiliary terminal case section 34; the cross-sectional shape of the recessed portion 33 of the cover plate 8 may be selected in accordance with the shape of the protruding portion 35, in other words, it suffices that at least one step portion to be inserted into the recessed portion of the cover plate 8 is formed in the section into which an arc enters. The positions at which the arc-extinguishing recessed portions 10b are formed are not limited to positions between the auxiliary stationary contact member holding sections 23 of the auxiliary contact mechanism 5, and may be at the peripheries of both ends of the main movable contact member 12 in accordance with an arrangement of magnetic poles of an arc-extinguishing permanent magnet.

### Second Embodiment

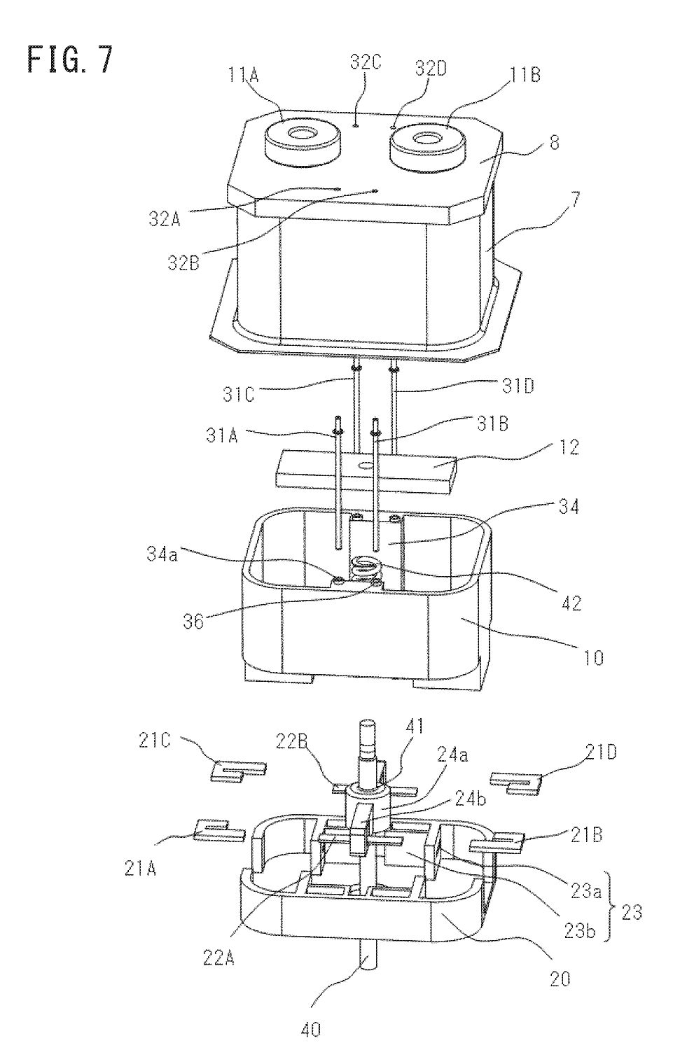

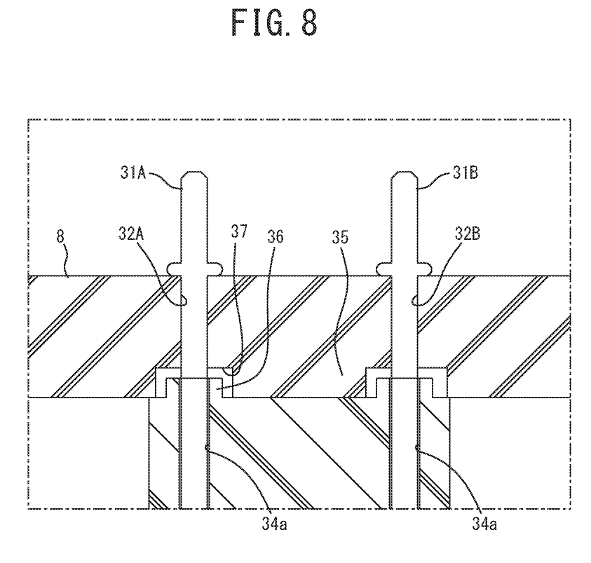

Next, a second embodiment according to the present invention will be described with reference to FIG. 7 and FIG. 8.

In an electromagnetic contactor according to the second embodiment, the protruding portions of the auxiliary terminal case section 34 are formed only around the pass-through sections 34a, and are funnel-shaped.

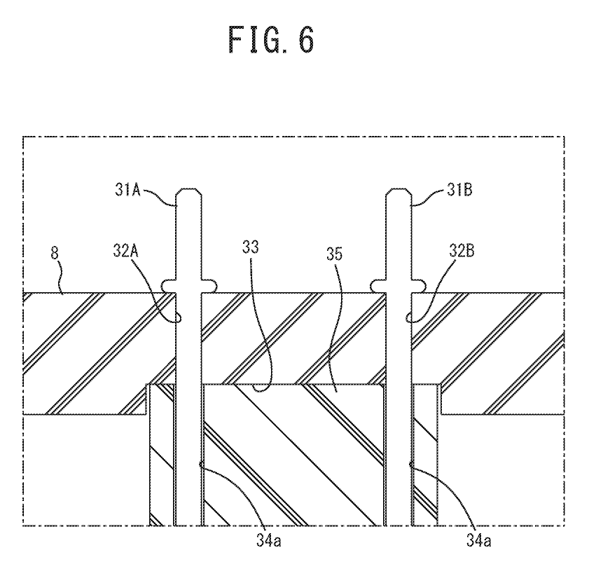

In other words, in contrast to the configuration illustrated in FIG. 6 of the aforementioned first embodiment in which the entire auxiliary terminal case section 34 projects from the upper end of the wall surface of the main contact case 10, funnel portions 36 projecting in a cylindrical shape are formed only around the auxiliary terminal pass-through sections 34a formed in the auxiliary terminal case section 34. In accordance with this, the recessed portion is formed on the back surface of the cover plate 8 by hollowing only the periphery of the through-hole 32 for the auxiliary terminal in a circular shape to form recessed portions 37 fitted with the funnel portions 36.

Since other components are similar to those of the aforementioned first embodiment, the same reference signs denote the corresponding components, and the detailed description is omitted.

By forming the step portion in a funnel shape in this manner, similarly to the first embodiment, the upper end of the auxiliary terminal case section 34 is higher than the wall surface of the main contact case 10; thus, the creepage distance between the auxiliary terminals 31A to 31D and the portion at which arc is generated through the gap between the cover plate 8 and the auxiliary terminal case section 34 becomes even longer, thereby preventing an arc from entering the gap to come into contact with the auxiliary terminals 31. Furthermore, even if an arc enters the gap between the cover plate 8 and the auxiliary terminal case section 34, paths leading to the auxiliary terminals 31A to 31D are blocked by the funnel portions 36 and arc travel distances become longer; thus preventing an arc from coming into contact with the auxiliary terminals 31A to 31D to generate short-circuiting.

It is to be noted that the funnel portion 36 is not limited to a cylindrical shape. Similarly, the recessed portion 37 is not limited to a circular shape, and may be any shape as long as it matches the funnel portion 36.

It is to be noted that, although the funnel portion 36 is formed in the aforementioned second embodiment, a funnel portion concentric with the funnel portion 36 may be formed on an outer peripheral side of the funnel portion 36, or a flange portion projecting in a radial direction on the upper face of the funnel portion 36 may be formed to increase the creepage distance even more.

### Third Embodiment

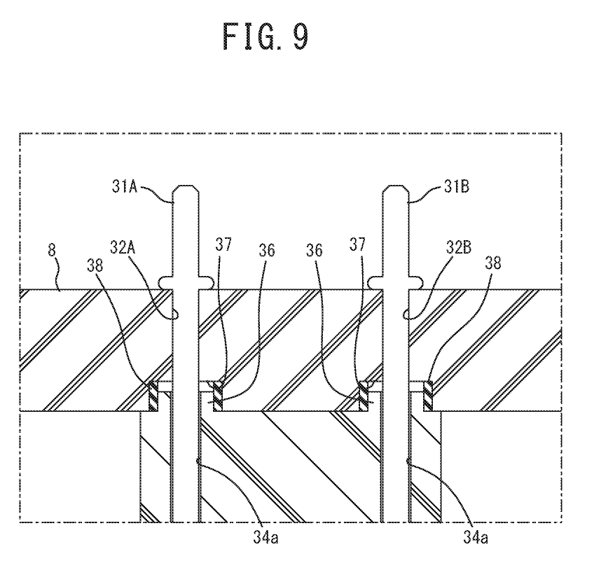

Next, a third embodiment according to the present invention will be described with reference to FIG. 9.

In the third embodiment, an insulating member is interposed between the cover plate 8 and the auxiliary terminal case section 34, thereby improving the insulation performance even more.

For example, in the configuration illustrated in FIG. 7 of the aforementioned second embodiment, an insulating member 38 formed of cylindrical insulating rubber or the like in a cylindrical shape is interposed between the funnel portion 36 of the auxiliary terminal case section 34 and the recessed portion 37 of the cover plate 8 and disposed such that it surrounds each of the auxiliary terminals 31A to 31D, thereby shielding each of the auxiliary terminals 31A to 31D from an arc.

According to the third embodiment, the insulating member 38 surrounds the funnel portion 36, thereby improving the insulation performance of an extinguishing chamber according to the second embodiment even more to prevent short-circuiting.

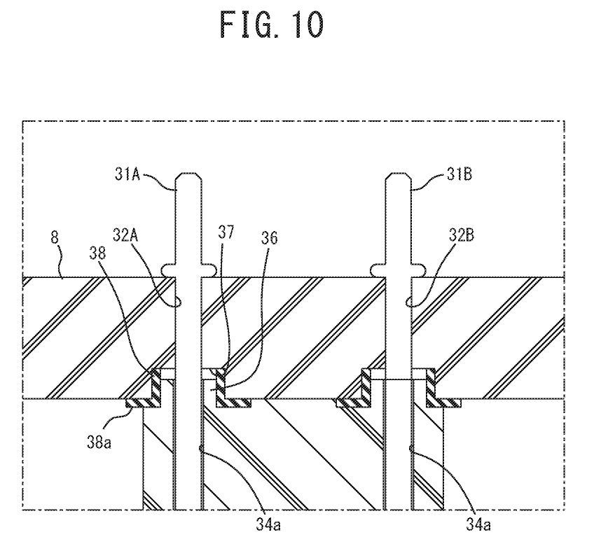

Although, in the third embodiment, a cylindrical insulating member has been described, when a flange portion 38a is formed at one end of the insulating member 38 as illustrated in FIG. 10, a sealing function filling the gap between the cover plate 8 and the auxiliary terminal case section 34 may be provided, thereby improving the insulation performance even more. In other words, by disposing an insulator at the periphery of the step portion, the auxiliary terminals 31A to 31D may be shielded from an arc, and insulation between the main contact unit and the auxiliary terminals is improved.

It is noted that the insulating member 38 is not limited to a cylindrical shape, and may be any shape as long as it matches the funnel portion 36.

### Fourth Embodiment

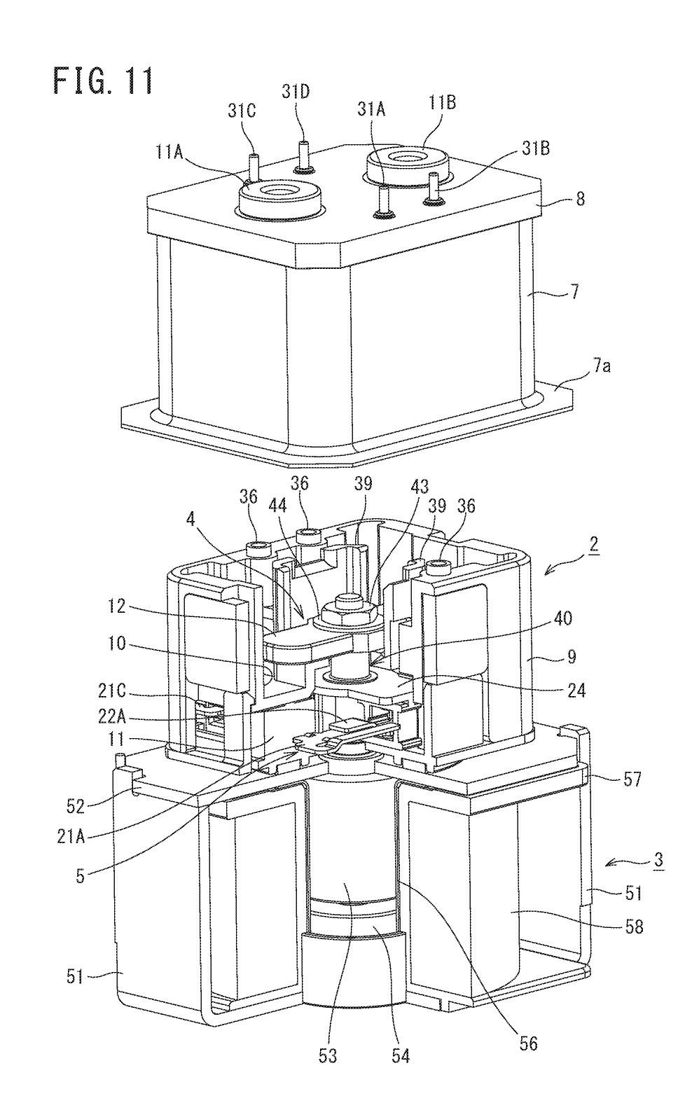

Next, a fourth embodiment according to the present invention will be described in association with FIG. 11 to FIG. 16.

In the fourth embodiment, the movable shaft 40 in the aforementioned second embodiment is divided into a main contact supporting section 61 and an auxiliary contact supporting section 62 on a lower end side of the spring receiving portion 61b. The main contact supporting section 61 and the auxiliary contact supporting section 62 are integrated by way of an auxiliary movable contact member holding section 24.

The main contact supporting section 61 is formed of, for example, a metallic material in a rod shape, has a flange 61a to be buried in the auxiliary movable contact member holding section 24 formed at one end, the flange 61a projecting in a radial direction, and has the spring receiving portion 61b formed at a position spaced apart from the flange 61a on the other end side, the spring receiving portion 61b having a larger diameter than the flange 61a and projecting in a radial direction.

On the other end side of the main contact supporting section 61, a supporting rod portion 61c inserted into the through-hole formed in the main movable contact member 12 of the main contact mechanism 4 and supporting the main movable contact member 12 movably in an axial direction is formed, and on the other end side of the supporting rod portion 61c, a male thread portion 61d having a smaller diameter than the supporting rod portion 61c is formed.

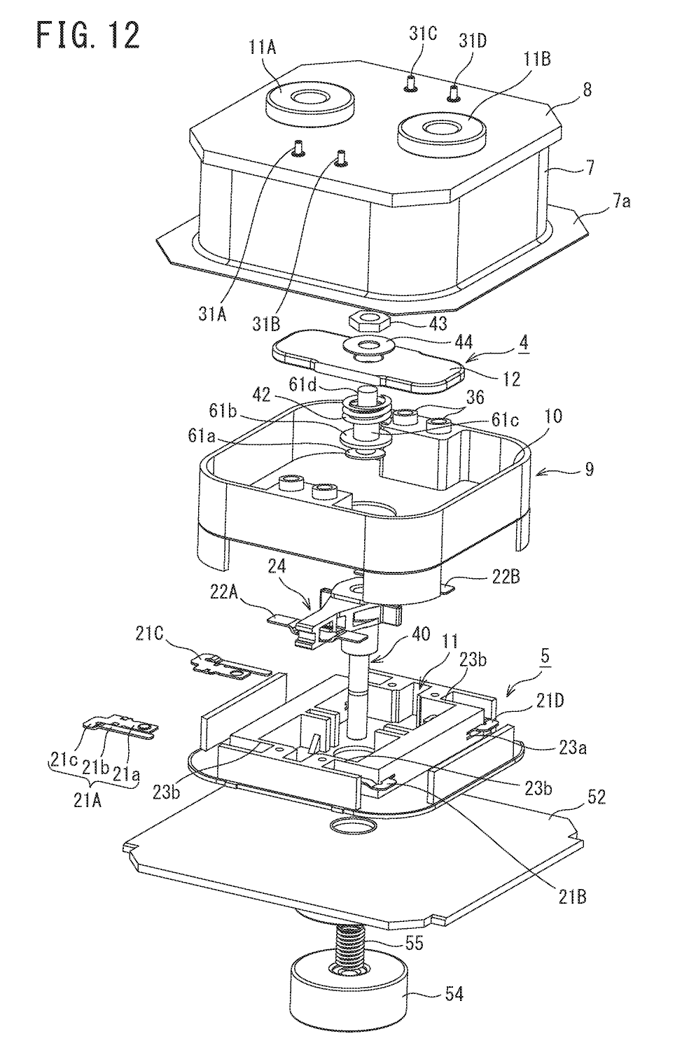

As illustrated in FIG. 12 to FIG. 15, the main movable contact member 12 is supported movably by the main contact supporting section 61. To support the main movable contact member 12, first, the main contact supporting section 61 is inserted into the contact spring 42 from the male thread portion 61d side to abut a lower end of the contact spring 42 against the spring receiving portion 61b. From this point, the main contact supporting section 61 is inserted into the through-hole of the main movable contact member 12 from the male thread portion 61d side, and the main movable contact member 12 is pressed from above to put the contact spring 42 into a contracted state. In this state, a washer 44 is mounted from the male thread portion 61d side, and subsequently, a nut 45 is screwed to the male thread portion 61d and fastened. In this manner, the main movable contact member 12 is slidably supported in the axial direction in a condition in which a certain contact pressure by the contact spring 42 is ensured.

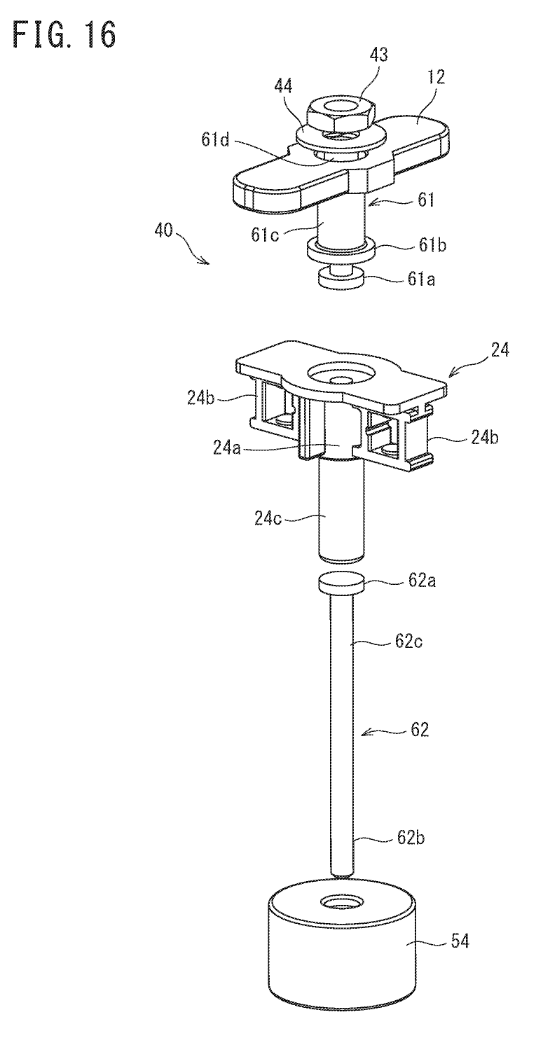

As illustrated in FIG. 16, the auxiliary contact supporting section 62 is formed of, for example, a metallic material in a rod shape, has a flange 62a to be buried in the auxiliary movable contact member holding section 24 formed at one end, and has a male thread portion 62b formed on the other end side.

The male thread portion 62b is screwed to a female thread portion of the movable core 54 of the electromagnet unit 3 to be described later and connected with the movable core 54.

The main contact supporting section 61 and the auxiliary contact supporting section 62 are then integrated by way of the auxiliary movable contact member holding section 24 to form the movable shaft 40.

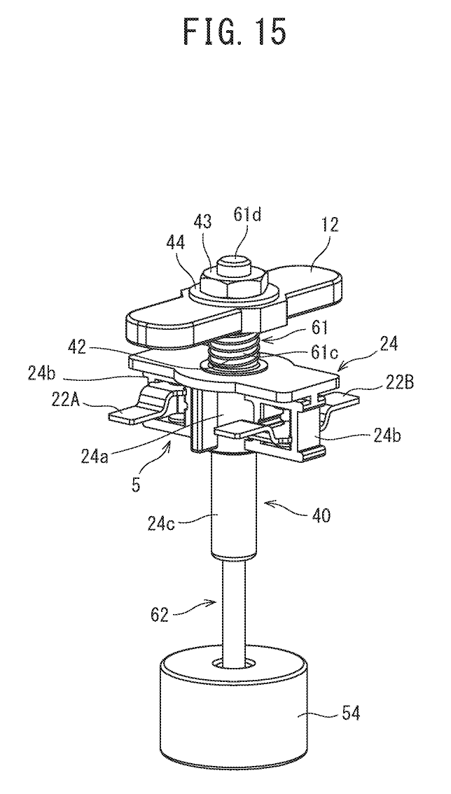

In the present embodiment, when the movable shaft 40 is formed, the flange 61a and the spring receiving portion 61b of the main contact supporting section 61 and the flange 62a of the auxiliary contact supporting section 62 are put into a mold for resin molding of the auxiliary movable contact member holding section 24, the flanges 61a and 62a are fixed in a state in which they are spaced apart from each other, and using so-called insert molding in which molten resin is injected into the mold under high pressure in this state and solidified, the movable shaft 40 is configured, as illustrated in FIG. 15, as an insert molded component formed by integrally molding the movable shaft 40 with the auxiliary movable contact member holding section 24.

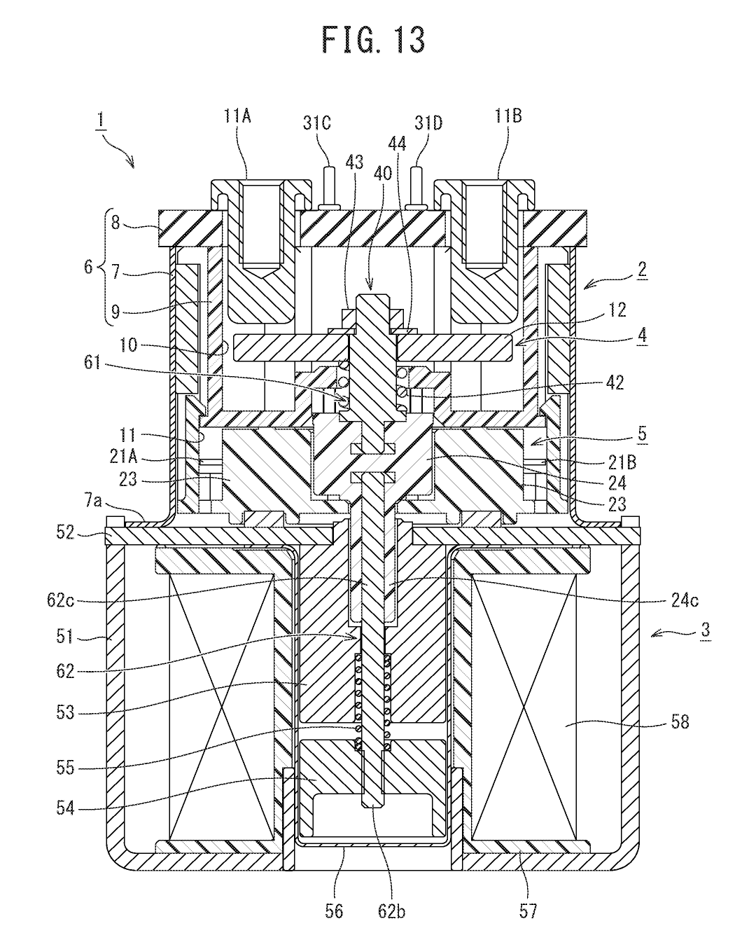

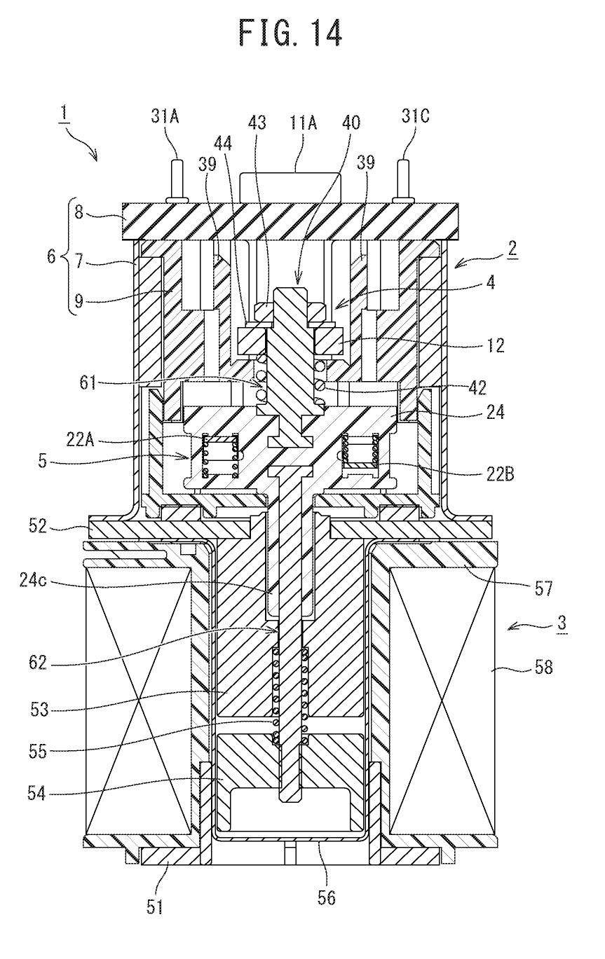

Therefore, as illustrated in FIG. 13 and FIG. 14, the main contact supporting section 61 and the flange 61a are respectively buried in the center of the auxiliary movable contact member holding section 24 and in a cylindrical connection portion 31c with an upper face of the spring receiving portion 61b aligned with an upper face of a plate portion 31a. With regard to the auxiliary contact supporting section 62, the flange 62a is buried in the auxiliary movable contact member holding section 24, and a supporting rod portion 62c connected with the flange 62a is buried in the center of a cylindrical extension portion 24c, formed on and projecting from a lower face of the cylindrical portion 24a of the auxiliary movable contact member holding section 24.

In the auxiliary terminal case section 34 formed in the main contact case 10, as illustrated in FIG. 11 and FIG. 12, four funnel portions 36 projecting upwards from an upper face of the auxiliary terminal case section 34 are formed. Into these funnel portions 36, the auxiliary terminals 31A to 31D are inserted through the through-holes 32A to 32D for the auxiliary terminals formed in the cover plate 8 from up above, and lower ends of the auxiliary terminals 31A to 31D are in elastic contact with the elastic plate portions 21b of the auxiliary stationary contact members 21A to 21D through the through-holes formed in the auxiliary terminal case section 34 and fixed. It is to be noted that a partition wall 39 is formed in the main contact case 10 between the auxiliary terminal case section 34 and the main movable contact member 12 to prevent the main movable contact member 12 from rotating as well as to prevent an arc from coming around.

According to the fourth embodiment, similarly to the aforementioned second embodiment, funnel portions 36 are formed on and projecting from an upper end face of the auxiliary terminal case section 34, a sufficient creepage distance may be secured for an arc generated when the main movable contact member 12 is released from a closed state in which the main stationary contact members 11A and 11B of the main contact device 2 and the main movable contact member 12 are in contact with each other by separating the main movable contact member 12 downwards; thus, an arc may be reliably extinguished.

In addition, with regard to the movable shaft 40 connected with the main movable contact member 12 of the main contact mechanism 4, the main contact supporting section 61 holding the main movable contact member 12 and the auxiliary contact supporting section 62 holding the auxiliary movable contact member holding section 24 of the auxiliary contact mechanism 5 are joined together by way of the auxiliary movable contact member holding section 24 made of an insulating material. Therefore, even if the main contact supporting section 61 and the auxiliary contact supporting section 62 are formed of a metallic material having a high conducting property, insulation between the main contact supporting section 61 and the auxiliary contact supporting section 62 maybe reliably assured with the auxiliary movable contact member holding section 24 intervening between them.

Thus, a charging unit applied with high voltage may be housed in the contact device 2 only, and the electromagnet unit 3 does not require a special measure for insulation such as a potting process using resin, thereby allowing the electromagnet unit 3 to have a simple configuration. In addition, an insulation distance between the movable core 54 or magnetic yokes 51, 52 and the excitation coil 58 may be shortened, and the size of the entire electromagnetic contactor 1 may be reduced by reducing the size of the electromagnet unit 3.

Furthermore, since junction of the main contact supporting section 61 and the auxiliary contact supporting section 62 constituting the movable shaft 40 may be achieved with the auxiliary movable contact member holding section 24, a separate joining member for joining the main contact supporting section 61 and the auxiliary contact supporting section 62 is not necessary; thus, the overall configuration may be simplified.

In addition, the movable shaft 40 is integrally formed by joining the main contact supporting section 61 and the auxiliary contact supporting section 62 and the auxiliary movable contact member holding section 24 using insert molding; thus, the movable shaft 40 including the auxiliary movable contact member holding section 24 may be formed easily and with high precision.

Furthermore, the main contact supporting section 61 constituting the movable shaft 40 is insert molded in the auxiliary movable contact member holding section 24, and accordingly, the flange 61a of the main contact supporting section 61 is buried in the auxiliary movable contact member holding section 24 and the spring receiving portion 61b having an area larger than the flange 61a is buried into a surface of the auxiliary movable contact member holding section 24; thus, the main contact supporting section 61 may be reliably prevented from slanting with respect to the auxiliary movable contact member holding section 24, and may sufficiently endure long-time use.

Furthermore, the cylindrical extension portion 24c covering the auxiliary contact supporting section 62 is formed in the auxiliary movable contact member holding section 24, and thus, the auxiliary contact supporting section 62 may be reliably prevented from slanting with respect to the auxiliary movable contact member holding section 24, and may sufficiently endure long-time use.

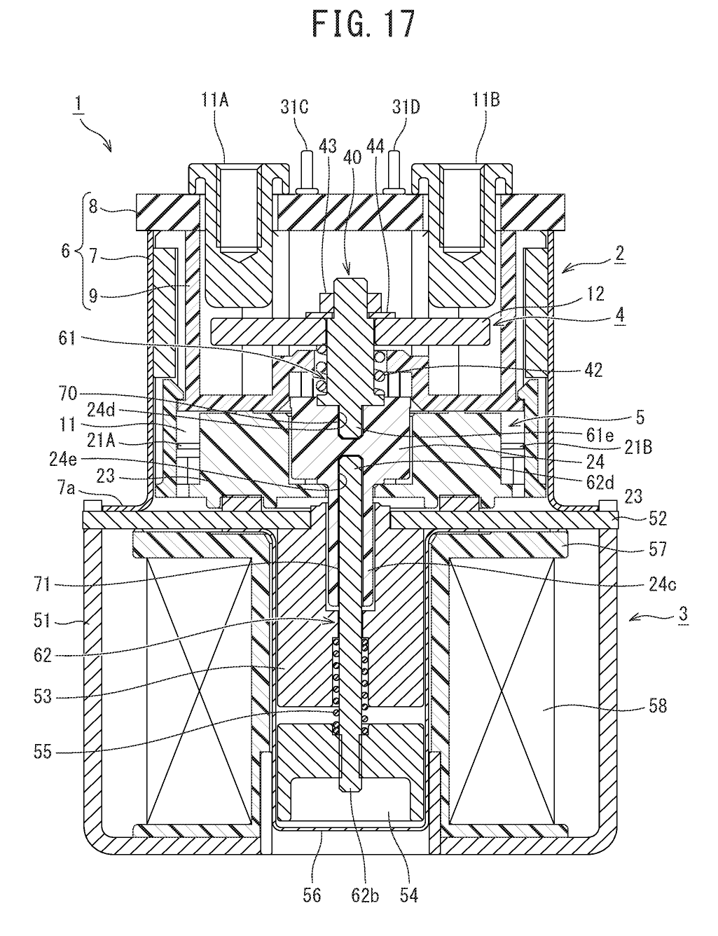

It is to be noted that, although in the aforementioned fourth embodiment, a case in which the main contact supporting section 61 and the auxiliary contact supporting section 62 are integrated by way of the auxiliary movable contact member holding section 24 using insert molding has been described, the present invention is not limited to the above configuration. For example, as illustrated in FIG. 17, the flange 61a of the main contact supporting section 61 and the flange 62a of the auxiliary contact supporting section 62 may be omitted, and an end portion 61e of the main contact supporting section 61 and an upper end 62d of the auxiliary contact supporting section 62 may be respectively fit into insertion holes 24d and 24e formed in the auxiliary movable contact member holding section 24 and bonded by an adhesive 70 and 71.

Alternatively, a male thread may be formed on end portions of the main contact supporting section 61 and the auxiliary contact supporting section 62, and the male thread may be screwed to a female thread portion formed in the auxiliary movable contact member holding section 24. In other words, it suffices that the main contact supporting section 61 and the auxiliary contact supporting section 62 are integrally connected by way of the auxiliary movable contact member holding section 24.

In addition, the funnel portion 36 in the fourth embodiment is not limited to the above configuration, and may be configured as a protruding portion in the first embodiment and a protruding portion and insulating rubber in the third embodiment.

Furthermore, although in the first to fourth embodiments, a case in which the main movable contact member 12 is disposed below the main stationary contact member 11A and 11B has been described, the present invention is not limited to this configuration; and the main stationary contact members 11A and 11B may be formed with an upper plate portion, a lower plate portion, and a connecting plate portion connecting these plate portions at one end in the main contact case 10 in a U-shape when viewed from a side, and the main movable contact member 12 is disposed between the upper plate portion and the lower plate portion to configure the main movable contact member 12 to come into and out of contact with the stationary contact portion formed on an upper face of the lower plate. In this case, the stationary core 53 and the movable core 54 of the electromagnet unit 3 are arranged upside down.

### REFERENCE SIGNS LIST

1 electromagnetic contactor

2 contact device

3 electromagnet unit

4 main contact mechanism

5 auxiliary contact mechanism

6 contact housing unit

7 outer square-cylindrical body

8 cover plate

9 insulating case

10 main contact case

11A, 11B main stationary contact member

12 main movable contact member

20 auxiliary contact case

21A to 21D auxiliary stationary contact member

22A, 22B auxiliary movable contact member

23 auxiliary stationary contact member holding section

24 auxiliary movable contact member holding section

31A to 31D auxiliary terminal

32 through-hole for auxiliary terminal

33, 37 recessed portion

34 auxiliary terminal case section

35 protruding portion

36 funnel portion

38 insulating member

40 movable shaft

51 lower magnetic yoke

52 upper magnetic yoke

53 stationary core

54 movable core

55 return spring

56 cap

57 spool

58 excitation coil

61 main contact supporting section

62 auxiliary contact holding section

70, 71 adhesive

1. A contact device comprising:
a main contact mechanism including a pair of main stationary contact members spaced apart from each other at a certain distance and a main movable contact member supported such that it can come into and out of contact with the main stationary contact members;
an auxiliary contact mechanism including auxiliary stationary contact members disposed at a position different from a position of the main contact mechanism, and spaced apart from each other at a certain distance and an auxiliary movable contact member supported such that it can come into and out of contact with the auxiliary stationary contact members;
a movable shaft configured to operate the main movable contact member and the auxiliary movable contact member in conjunction with each other;
a rod-shaped auxiliary terminal electrically connected to the auxiliary stationary contact member; and
a contact housing unit comprising a cover plate having a hole through which the auxiliary terminal penetrates, an insulating case configured to house the main contact mechanism and the auxiliary contact mechanism and including an auxiliary terminal case section configured to separate the main contact mechanism and the auxiliary contact mechanism from each other, and a cylindrical body covering the insulating case exteriorly and joined to the cover plate, wherein fitting portions fitted with each other are formed in junction sections of the cover plate and the auxiliary terminal case section.

2. The contact device according to claim 1, wherein the insulating case comprises a main contact case configured to house the main contact mechanism and an auxiliary contact case configured to house the auxiliary contact mechanism, wherein the main contact case and the auxiliary contact case are housed in the cylindrical body facing against the cover plate in this order, and wherein the auxiliary terminal case section is formed in the main contact case.

3. The contact device according to claim 2, wherein the auxiliary terminal case section is formed on an inner wall of the main contact case along the cylindrical body.

4. The contact device according to claim 2, wherein the auxiliary terminal case section is formed on the inner wall surface of the main contact case facing against the center of the main movable contact member in a longitudinal direction, and wherein in the main contact case, arc-extinguishing recessed portions are formed on a side opposite to the main stationary contact members on both ends of the main movable contact member.

5. The contact device according to claim 1, wherein the fitting portion on the cover plate side is a recessed portion and the fitting portion on the insulating case side is a protruding portion.

6. The contact device according to claim 5, wherein the protruding portion is a funnel shape covering an outer circumference of the auxiliary terminal.

7. The contact device according to claim 1, wherein an insulating member is interposed in the periphery of the fitting portions.

8. The contact device according to claim 7, wherein the insulating member is a cylindrical shape.

9. The contact device according to claim 8, wherein the insulating member has a flange portion formed at one end.

10. The contact device according to claim 1, wherein the movable shaft is divided into two sections including a main contact supporting section supporting the main movable contact member and an auxiliary contact supporting section supporting the auxiliary movable contact member, and wherein the main contact supporting section and the auxiliary contact supporting section are integrated by way of an auxiliary movable contact member holding section.

11. An electromagnetic contactor including the contact device according to claim 1.

12. The contact device according to claim 2, wherein the fitting portion on the cover plate side is a recessed portion and the fitting portion on the insulating case side is a protruding portion.

13. The contact device according to claim 3, wherein the fitting portion on the cover plate side is a recessed portion and the fitting portion on the insulating case side is a protruding portion.

14. The contact device according to claim 4, wherein the fitting portion on the cover plate side is a recessed portion and the fitting portion on the insulating case side is a protruding portion.

15. The contact device according to claim 2, wherein an insulating member is interposed in the periphery of the fitting portions.

16. The contact device according to claim 3, wherein an insulating member is interposed in the periphery of the fitting portions.

17. The contact device according to claim 4, wherein an insulating member is interposed in the periphery of the fitting portions.

18. The contact device according to claim 5, wherein an insulating member is interposed in the periphery of the fitting portions.

19. The contact device according to claim 6, wherein an insulating member is interposed in the periphery of the fitting portions.

20. The contact device according to claim 2, wherein the movable shaft is divided into two sections including a main contact supporting section supporting the main movable contact member and an auxiliary contact supporting section supporting the auxiliary movable contact member, and wherein the main contact supporting section and the auxiliary contact supporting section are integrated by way of an auxiliary movable contact member holding section.
